(19) United States
(12) Patent Application Publication
(10) Pub. No.: US 2024/0049031 A1
(43) Pub. Date: Feb. 8, 2024

(54) COORDINATION FOR CELL MEASUREMENTS AND MOBILITY

(71) Applicant: QUALCOMM Incorporated, San Diego, CA (US)

(72) Inventors: Shankar KRISHNAN, San Diego, CA (US); Jelena DAMNJANOVIC, Del Mar, CA (US); Ozcan OZTURK, San Diego, CA (US); Xipeng ZHU, San Diego, CA (US); Tao LUO, San Diego, CA (US); Shanyu ZHOU, San Diego, CA (US); Punyaslok PURKAYASTHA, San Diego, CA (US)

(21) Appl. No.: 18/347,196

(22) Filed: Jul. 5, 2023

Related U.S. Application Data
(60) Provisional application No. 63/370,779, filed on Aug. 8, 2022.
(60) Provisional application No. 63/396,211, filed on Aug. 8, 2022.

(51) Int. Cl. H04W 24/10

(52) U.S. Cl. CPC H04W 24/10

(57) ABSTRACT

Certain aspects of the present disclosure provide a method of wireless communication. An example method, performed at a first network entity, includes receiving a measurement report from a user equipment (UE) that supports dynamic mobility signaling via physical (PHY) layer or medium access control (MAC) layer signaling, wherein the measurement report includes at least one of PHY layer or MAC layer measurements, and transmitting the measurement report to a second network entity, based on an event trigger.

### CROSS-REFERENCE TO RELATED APPLICATIONS

This application claims priority to U.S. Provisional Application No. 63/396,211, filed Aug. 8, 2022, and U.S. Provisional Application No. 63/370,779, filed Aug. 8, 2022, which are both assigned to the assignee hereof and hereby expressly incorporated by reference in their entireties as if fully set forth below and for all applicable purposes.

### BACKGROUND

### Field of the Disclosure

Aspects of the present disclosure relate to wireless communications, and more particularly, to techniques to support mobility of a user equipment (UE) between cells that support cell changes via dynamic signaling.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a first network entity. The method includes receiving a measurement report from a user equipment (UE) that supports dynamic mobility signaling via physical (PHY) layer or medium access control (MAC) layer signaling, wherein the measurement report includes at least one of PHY layer or MAC layer measurements; and transmitting the measurement report to a second network entity, based on an event trigger.

Another aspect provides a method of wireless communication at a second network entity. The method includes configuring a user equipment (UE) for dynamic mobility signaling via physical (PHY) layer or medium access control (MAC) layer signaling; and receiving, from a first network entity, a measurement report that includes at least one of PHY layer or MAC layer measurements taken by the UE, based on an event trigger.

Another aspect provides a method of wireless communication at a first network entity. The method includes transmitting, to a second network entity, information regarding one or more cell group configurations for the first network entity; and receiving signaling, from the second network entity, identifying at least a third network entity and one or more cells served thereby.

Another aspect provides a method of wireless communication at a second network entity. The method includes receiving, from at least a first network entity, information regarding one or more cell group configurations; deciding, from the one or more cell group configurations, a first set of cells to configure for dynamic mobility signaling via physical (PHY) layer or medium access control (MAC) layer signaling; and transmitting signaling, to the at least the first network entity affiliated with the configured set of cells, to identify the at least the first network entity and cells served thereby.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIG. 4A, FIG. 4B, FIG. 4C, and FIG. 4D depict various example aspects of data structures for a wireless communications network.

FIG. 5 depicts an example of UE mobility, in accordance with some aspects of the present disclosure.

FIG. 6, FIG. 7, FIG. 8, and FIG. 9 depict example call flow diagrams for configuring mobility based on dynamic signaling, in accordance with some aspects of the present disclosure.

FIG. 10 depicts an example call flow diagram for configuring mobility based on dynamic signaling, in accordance with some aspects of the present disclosure.

FIG. 11 depicts an example of UE mobility, in accordance with some aspects of the present disclosure.

FIG. 12 depicts an example call flow diagram for configuring mobility based on dynamic signaling, in accordance with some aspects of the present disclosure.

FIG. 13 depicts an example call flow diagram for configuring mobility based on dynamic signaling, in accordance with some aspects of the present disclosure.

FIG. 14 depicts an example of UE mobility, in accordance with some aspects of the present disclosure.

FIG. 15 depicts an example call flow diagram for configuring mobility based on dynamic signaling, in accordance with some aspects of the present disclosure.

FIG. 16 depicts an example call flow diagram for configuring mobility based on dynamic signaling, in accordance with some aspects of the present disclosure.

FIG. 17 depicts a method for wireless communications.

FIG. 18 depicts a method for wireless communications.

FIG. 19 depicts a method for wireless communications.

FIG. 20 depicts a method for wireless communications.

FIG. 21 depicts aspects of an example communications device.

### DETAILED DESCRIPTION

Aspects of the present disclosure provide apparatuses, methods, processing systems, and computer-readable mediums for supporting mobility of a user equipment (UE) between cells that support cell changes via dynamic signaling.

In advanced wireless systems, mobility and beam management procedures are in place to help maintain network connections for a user equipment (UE) as it moves between the coverage areas of different cells. Mobility procedures generally refer to mechanisms that allow a UE to transition from being served by a source cell to being served by a target cell. Beam management procedures generally refer to mechanisms for selecting beams suitable for communicating with a network entity, such as a transmission reception point (TRP), of one or more cells.

In multi-beam operation, more efficient uplink/downlink beam management may allow for increased intra-cell and inter-cell mobility (e.g., L1 and/or L2-centric mobility) and/or a larger number of transmission configuration indicator (TCI) states. For example, the states may enable the use of a common beam for data and control transmission and reception for UL and DL operations and enhanced signaling mechanisms to improve latency and efficiency.

In some cases, one or more components of a base station may be disaggregated, including a central unit (CU), one or more distributed units (DUs), and one or more radio units (RUs). In such cases, a CU may communicate with one or more DUS via respective midhaul links, such as an F1 interface, while DUs may communicate with one or more RUs via respective fronthaul links. The RUs may represent cells and may communicate with respective UEs via one or more radio frequency (RF) access links.

One challenge in implementing L1/L2 based inter-cell mobility in such disaggregated systems is how to communicate between different components, when needed. For example, various types of information may need to be exchanged between a CU and DU, or between DUs, to support L1/L2 based inter-cell mobility.

Aspects of the present disclosure provide various mechanisms and options for CU-DU interface signaling to support L1/L2 based inter-cell mobility. The mechanisms proposed herein help define responsibilities of various nodes during L1/L2 mobility. The mechanisms also allow a DU to be informed about the cells served by other DUs, that are part of a set of cells configured to support L1/L2 based inter-cell mobility (referred to herein as a configured cell set) and also to inform a CU and DUs about inter-DU primary serving cell (PCell) changes. The mechanisms proposed herein may help reduce latency and achieve efficient use of signaling resources, as a UE moves between cells.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

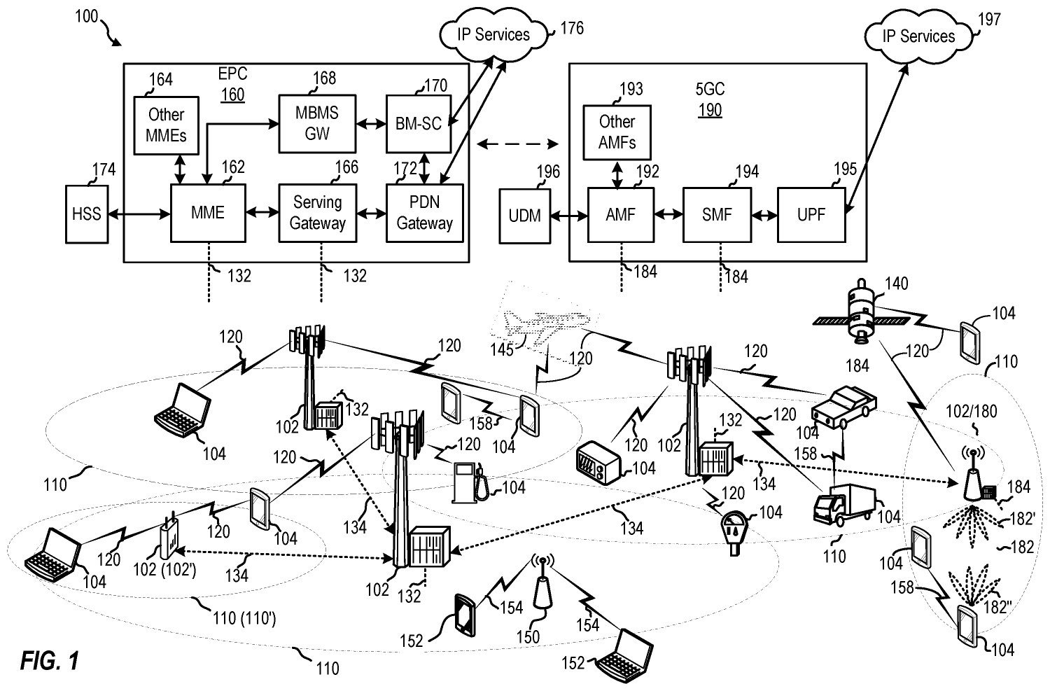

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

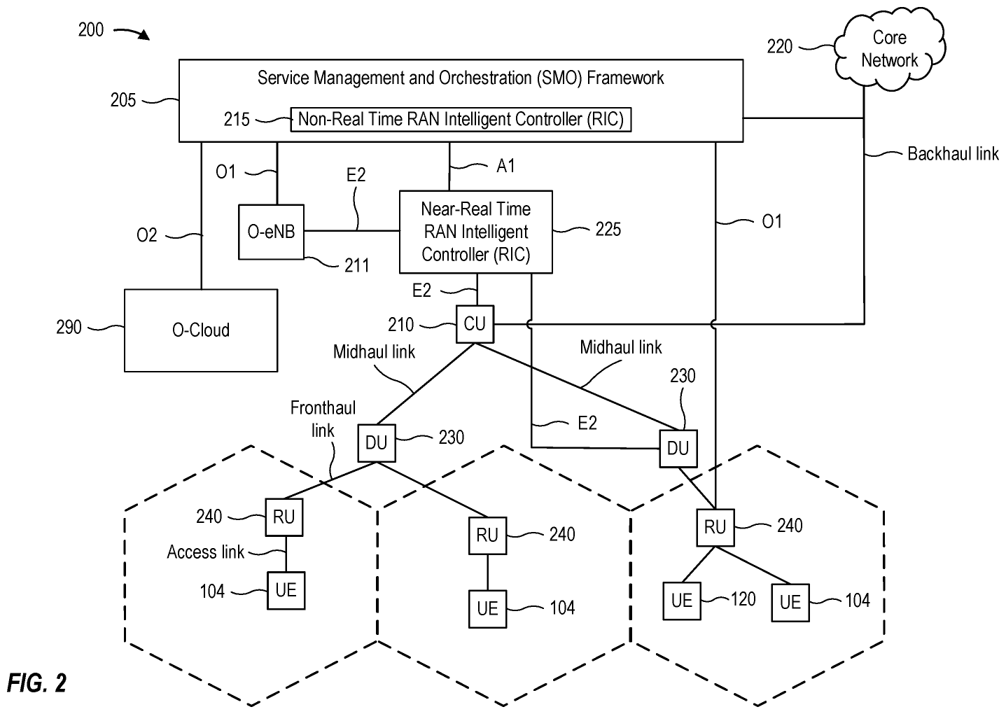

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of (an aggregated or disaggregated) base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

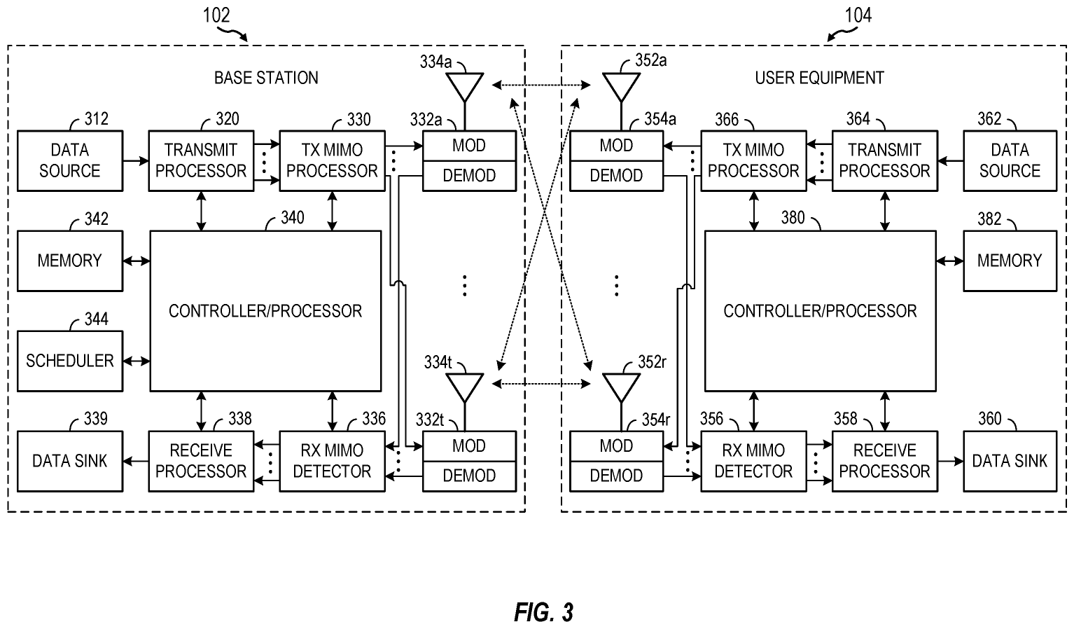

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

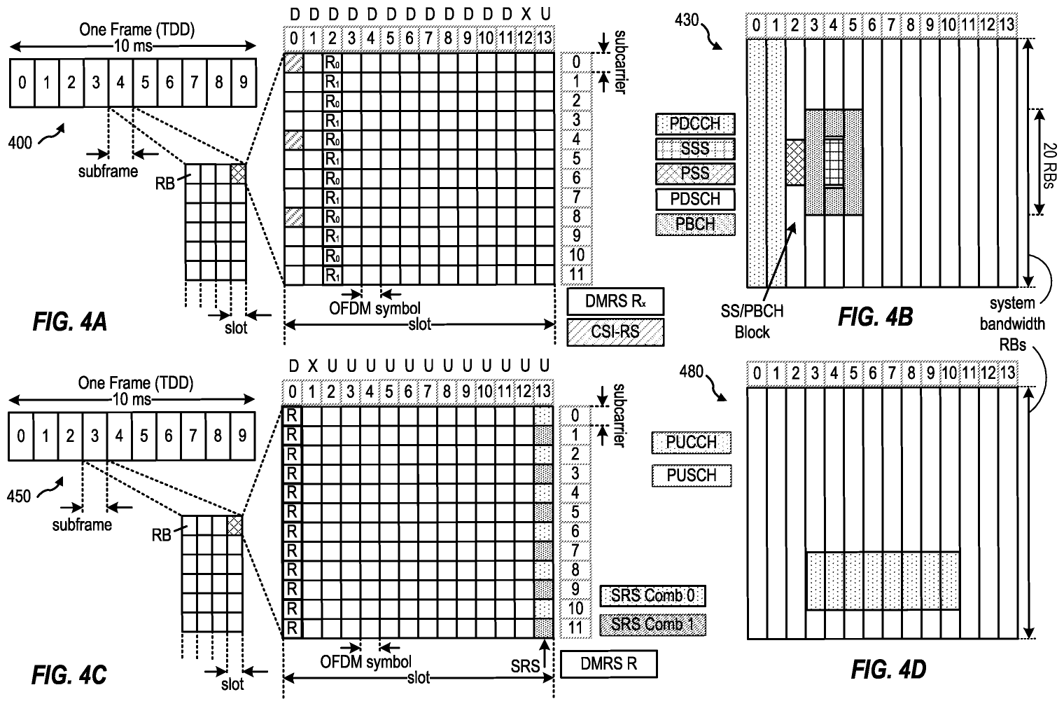

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ×}15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of CA Cell Groups

In carrier aggregation (CA), cells may be divided into groups referred to as a master cell group (MCG) and a secondary cell group (SCG). A UE that supports dual connectivity (DC) may establish a connection with cells in both the MCG and SCG. The MCG may be a group that includes a cell in which the UE first initiates random access channel (RACH) procedure.

There may be many different types of cells under the MCG. One cell used for initial access is referred to as a primary cell (PCell). The PCell in the MCG and a secondary cell (SCell) in the MCG are effectively combined using CA. There is also a primary cell in the SCG, referred to as a PSCell, for which initial access is initiated under the SCG. The PSCell and SCell under the SCG may also be effectively combined through CA. Because most signaling messages are sent only on the PCell and PSCell, the protocol also defines a concept a special cell (sPCell), which refers to the PCell and PSCell.

### Overview of Dynamic Signaling-Based Mobility

Dynamic mobility signaling (e.g., L1 and/or L2-centric mobility) may lead to more efficient beam management and may facilitate intra-cell and inter-cell mobility with reduced latency.

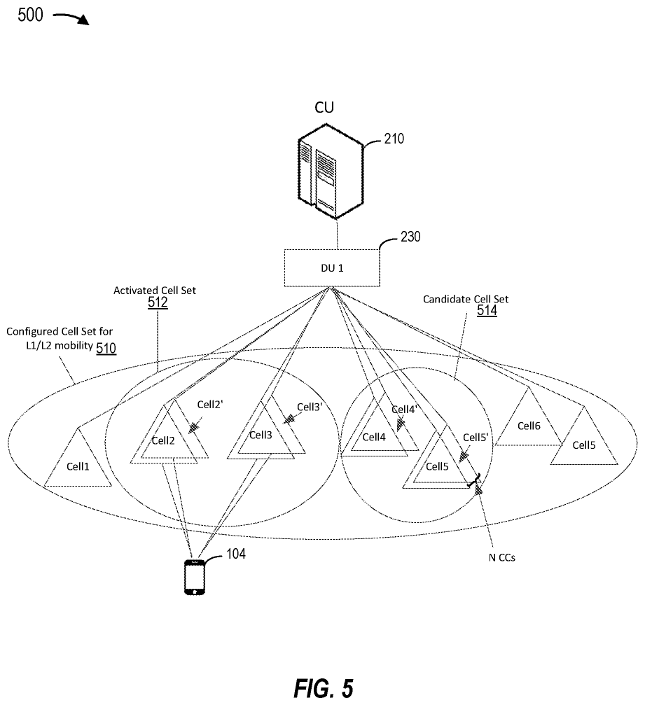

The general concept of L1/L2 based mobility signaling may be understood with reference to FIG. 5. As illustrated, the network may configure (e.g., via RRC signaling), a set of cells 510 for L1/L2 mobility (referred to herein as an L1/L2 Mobility Configured cell set). At any given time, the network may also configure (via L1/L2 signaling) an L1/L2 Mobility Activated cell set 512, which refers to a group of cells in the configured set that are activated and can be readily be used for data and control transfer. The network may also configure (signal) an L1/L2 Mobility Deactivated cell set, which refers to a group of cells in in the configured set that are deactivated and can be readily be activated by L1/L2 signaling.

L1/L2 signaling may be used for mobility management of the activated set. For example, L1/L2 signaling may be used to activate/deactivate cells in the set, select beams within the activated cells, and update/switch a PCell. This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

As in the example illustrated in FIG. 5, in some cases, all cells in the L1/L2 Mobility Configured cell set may belong to the same DU 230 associated with a CU 210. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set 514, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

As illustrated in FIG. 5, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For primary cell (PCell) management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

### Overview of Configuration for Dynamic Signaling-Based Mobility

Exactly how a UE and network components (e.g., DUs) are configured for dynamic signaling (L1/L2) based mobility may depend on a particular procedure in which corresponding configuration information is conveyed.

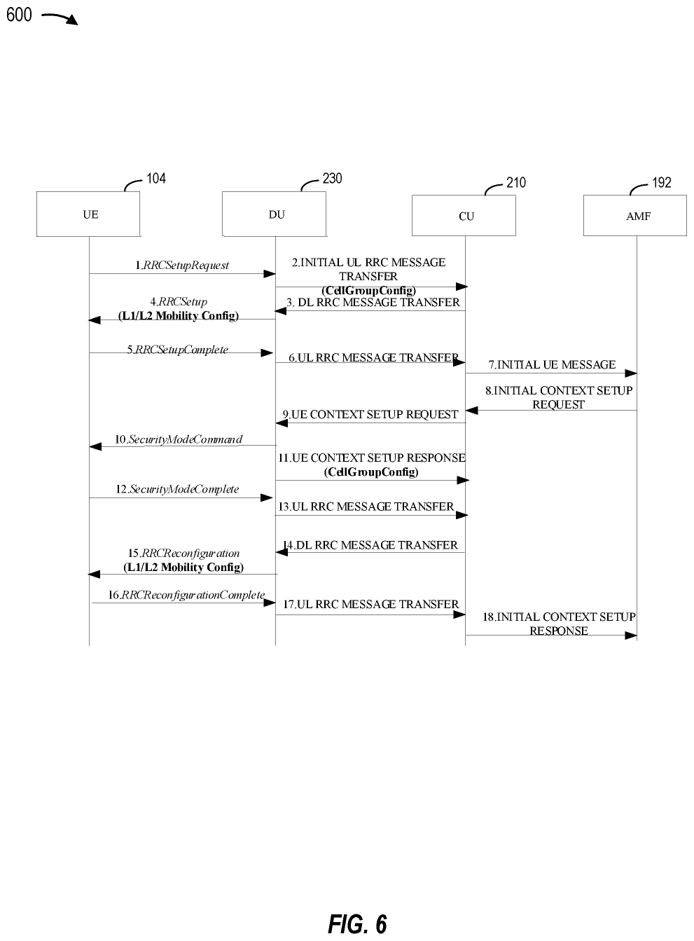

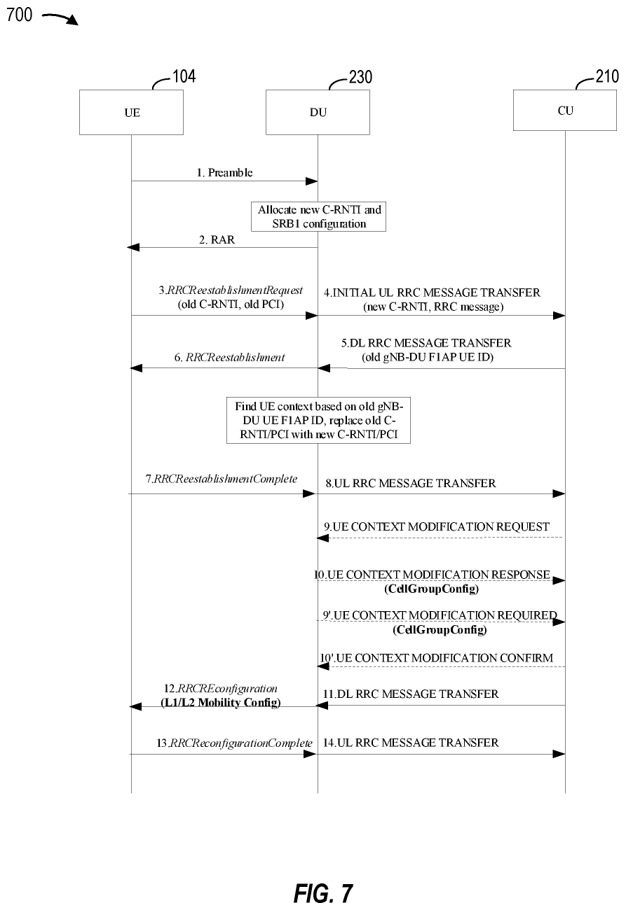

For example, as illustrated in call flow diagram 600 of FIG. 6, during an initial access procedure for a UE, a DU may generate cell group configuration information. The DU may send this information to a CU, for example, via a DU to CU RRC Container IE in an INITAL UL RRC MESSAGE TRANSFER (at step 2). The CU may then signal the L1/L2 mobility configuration to the UE in an RRC Setup message, at steps 3-4, which may be transparent to the DU. In some cases, at step 11, the DU may also generate the cell group configuration information and send the information to the CU (e.g., via DU to CU RRC Information IE in UE CONTEXT SETUP RESPONSE). As illustrated, at steps 14-15, the CU may then signal the L1/L2 mobility configuration information to the UE, for example, in an RRC Reconfiguration message (which may be transparent to the DU as the DU may simply forward this message on).

As illustrated in call flow diagram 700 of FIG. 7, during an RRC Reestablishment procedure, a DU may generate the cell group configuration information and sends it to the CU. The cell group configuration information may be sent, for example, via a DU to CU RRC Information IE in a UE CONTEXT MODIFICATION RESPONSE message (step 10) or a UE CONTEXT MODIFICATION REQUIRED message (step 9′). At steps 11-12, the CU may then signal the L1/L2 mobility configuration information to the UE (e.g., in an RRCReconfiguration message (which may be transparent to the DU).

As illustrated in call flow diagram 800 of FIG. 8, during an RRC Resume procedure, a DU may generate the cell group configuration information and send this information to the CU (e.g., via DU to CU RRC Information IE in UE CONTEXT SETUP RESPONSE). At steps 7-8, the CU may then signal the L1/L2 mobility configuration information to the UE (e.g., in an RRC Reconfiguration message transparent to DU).

As illustrated in call flow diagram 900 of FIG. 9, during an Inter-DU mobility update procedure (where a UE moves from a source DU to a target DU), at step 4, the target DU may update cell group configuration information and send this information to the CU (e.g., via a DU to CU RRC Information IE in a UE CONTEXT SETUP RESPONSE). At steps 5-6, the CU may signal the L1/L2 mobility configuration information to the UE (e.g., in an RRC Reconfiguration message, transparent to DU).

### Aspects Related to Coordination of L1/L2 Measurements for L1/L2 Based Mobility

Aspects of the present disclosure provide apparatuses, methods, processing systems, and computer-readable mediums for supporting mobility of a UE between cells that support cell changes via dynamic signaling. Mobility based on dynamic signaling is referred to herein as L1/L2 based inter-cell mobility, because it is based on physical (PHY) layer (Layer1/L1) or medium access control (MAC) layer (Layer2/L2) signaling mechanisms. These mechanisms may include PDCCH/DCI for L1 and MAC control elements (MAC CEs) for L2.

As noted above, one potential challenge in implementing L1/L2 based inter-cell mobility in disaggregated systems is how to communicate between different network entities (e.g., components of a disaggregated base station). For example, various types of information may need to be exchanged between a CU and DU, between DUs, or between CUs, to support L1/L2 based inter-cell mobility. Aspects of the present disclosure provide various mechanisms and options for signaling between network entities (e.g., via a CU-DU interface, DU-DU interface, or CU-CU interface) to support L1/L2 based inter-cell mobility.

Disaggregated base station (gNB) components, such as DUs and a CU may have different responsibilities in a system that supports L1/L2 based inter-cell mobility.

For example, a DU may be responsible for obtaining L1/L2 measurements from UE. The DU may use the measurements to determine which cells to activate/deactivate within the configured cell set. The DU may also use the measurements to determine when to switch the PCell within the activated cell set. The mechanisms proposed herein may help ensure DUs are able to obtain L1/L2 measurement reports from a UE.

Aspects of the present disclosure provide options for signaling between network entities to support L1/L2 mobility. According to certain aspects, mechanisms provided herein may help a CU to collect L1/L2 measurements from a DU. According to certain aspects, mechanisms provided herein may allow a DU to subscribe for L1/L2 measurements.

It may be beneficial for a DU to be able to send L1/L2 measurement reports obtained from a UE to a CU in a transparent container. There are various options for how the DU may send the measurement reports, for example, based on one or more event triggers.

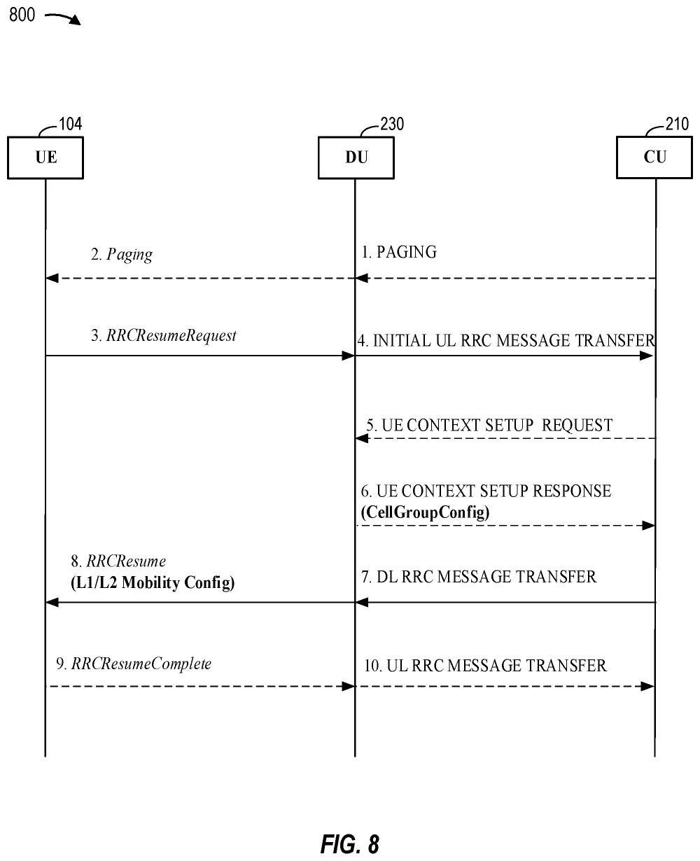

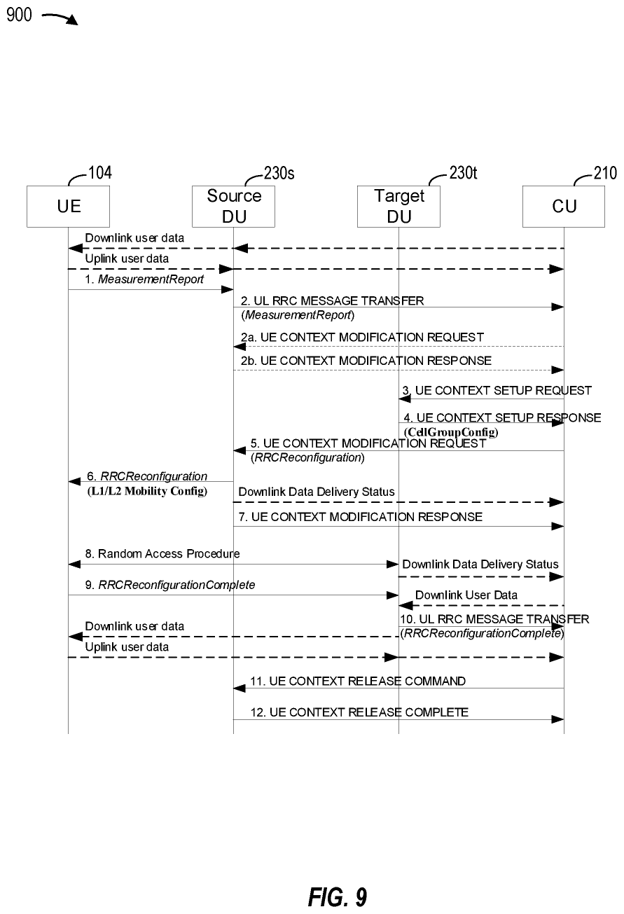

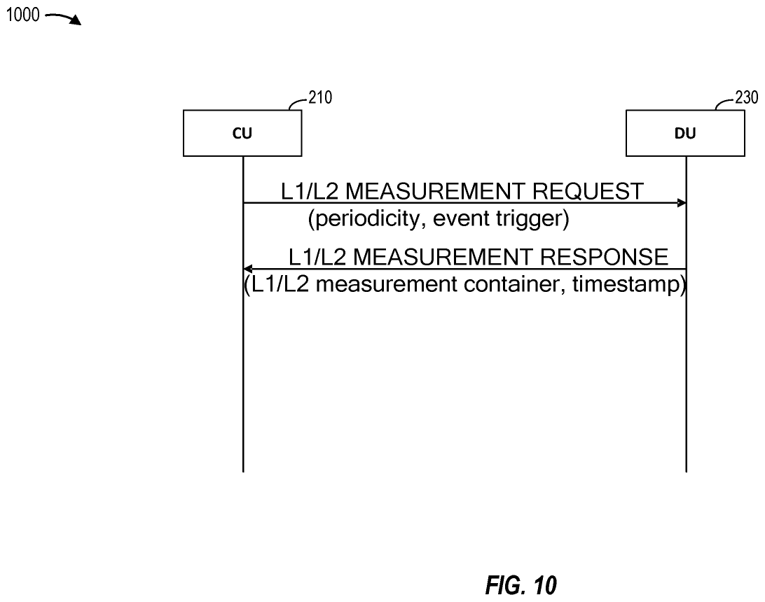

FIG. 10 illustrates one example of signaling between network entities to support L1/L2 mobility. While the call flow diagram 1000 of FIG. 10 involves signaling between a CU and DU, the techniques may be applied to signaling between other types of network entities, such as between DUs (DU-DU) or between CUs (CU-CU).

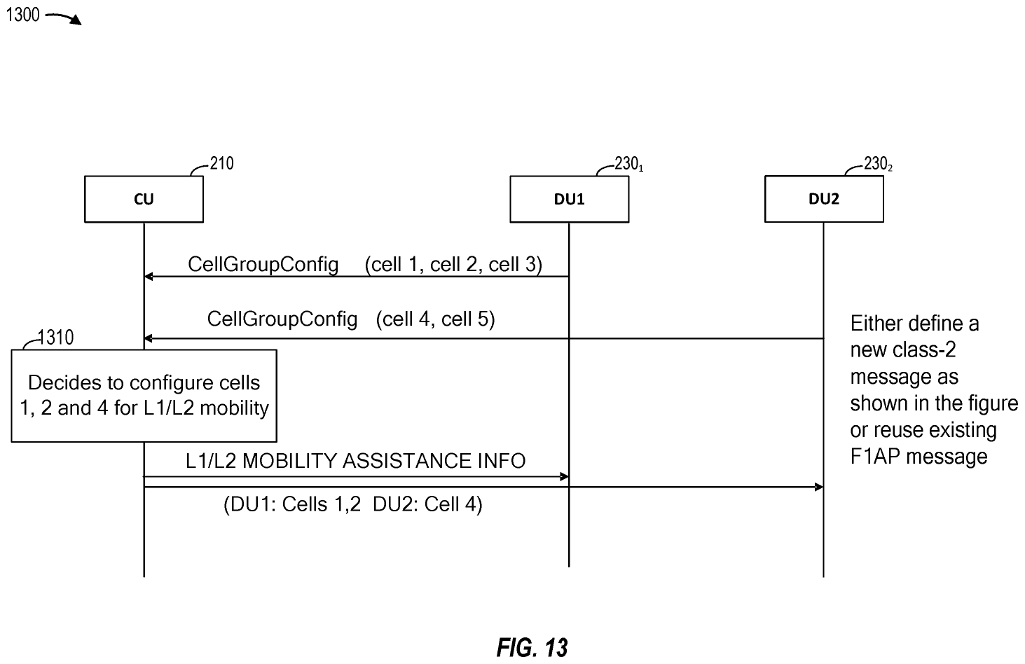

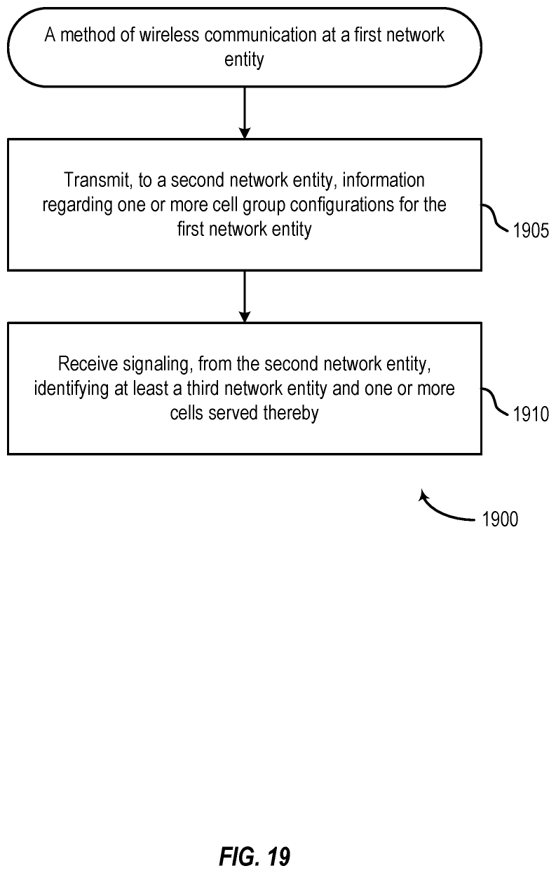

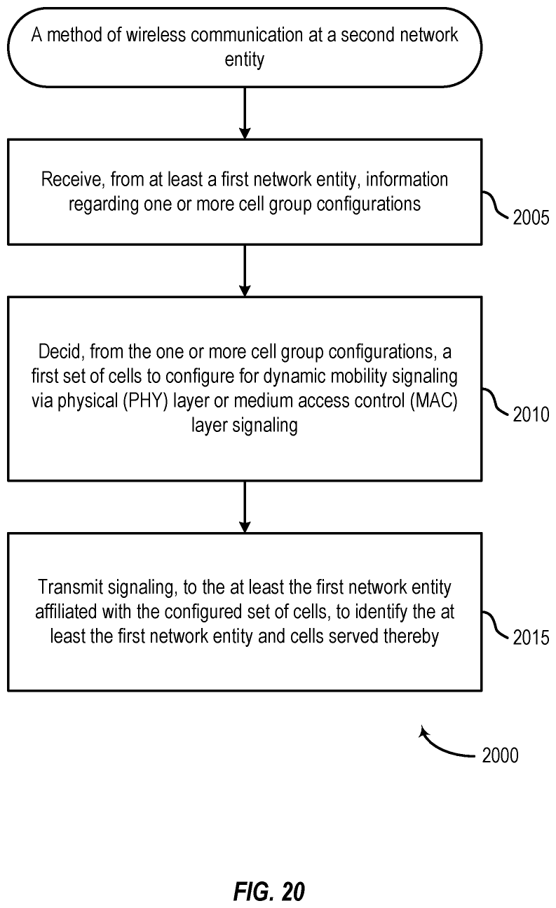

As illustrated in the call flow diagram 1000 of FIG. 10, according to a first option, the event trigger may correspond to a request from a CU or the event trigger may occur at a certain configured periodicity, one-shot, upon some certain conditional event trigger, or upon reception of a measurement report from a UE. The measurement report may be sent in response to the request. As illustrated, the DU may include other information with the measurement report, such as a timestamp of L1/L2 measurements, as well as a DU ID and a target cell ID. In some cases, the DU ID and target cell ID may be determined as part of a cell group configuration procedure (e.g., as discussed below with respect to FIG. 13, FIG. 19, and FIG. 20).

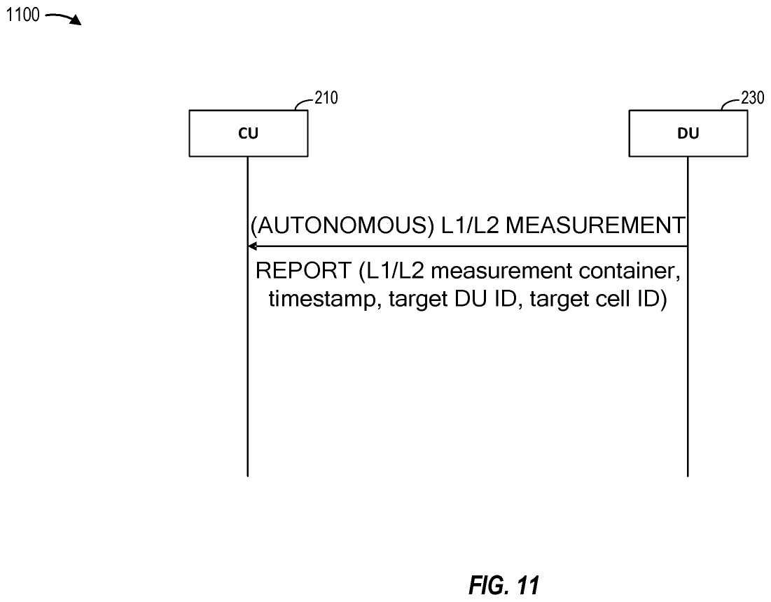

As illustrated in the call flow diagram 1100 of FIG. 11, according to a second option, the DU may send the measurement report to the CU autonomously. In case of an autonomous reporting by the DU, the DU may also indicate the target DU ID and target cell ID, for example, to which the L1/L2 measurement report is to be forwarded. Examples of event trigger conditions, or conditions that trigger autonomous reporting, can be based on radio quality. For example, reporting may be triggered if an absolute or relative channel quality exceeds or falls below a threshold.

In some cases, the measurement report may be sent in a message for an elementary procedure (EP) without response (such messages may be referred to as Class 2 messages) or an application protocol (AP) message. For example, the measurements may be conveyed in a new Class 2 message or in an existing F1 AP message (reused for this purpose).

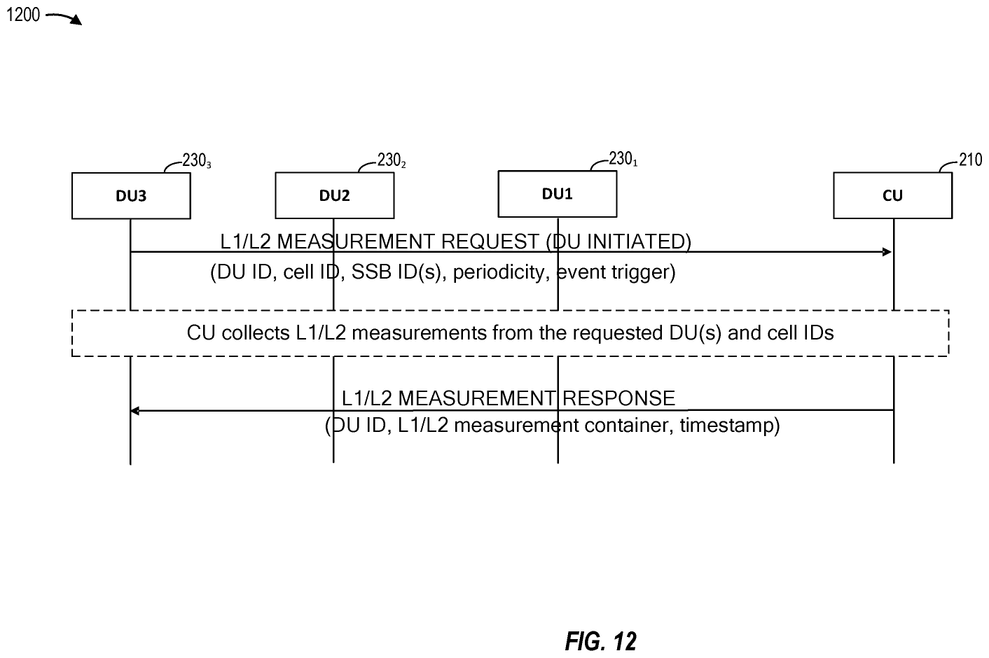

As illustrated in the call flow diagram 1200 of FIG. 12, in some cases, a DU may be able to selectively request or subscribe to L1/L2 measurement reports from certain cells or a subset of SSB beams, belonging to one or more other DUs.

In the example illustrated in FIG. 12, a first DU, DU3 230₃, sends a request to the CU 210 (to subscribe) to receive L1/L2 measurements from other DUs, DU1 230₁ and DU2 230₂.

As illustrated, in such cases, the CU may effectively act as a transparent relay node and forward the L1/L2 measurements received from the different DUs (DU1 and DU2) to the requesting DU (e.g., DU3 in case of subscription). The CU may also forward measurement reports to a target DU (in case of autonomous collection at the CU) or autonomously to a “primary serving DU” based on the CU's own knowledge to assist in PCell switching.

The DU may use the measurements to determine which cells to activate/deactivate, within a configured cell set, and/or when to switch the PCell within the activated cell set.

Mechanisms proposed herein may also help define responsibilities of various nodes during L1/L2 mobility. The mechanisms may allow a network entity to be informed about the cells served by other network entities, that serve cells that are part of a set of cells configured to support L1/L2 based inter-cell mobility (referred to herein as a configured cell set). For example, the mechanisms may allow a DU to be informed about the cells served by other DUs, that are part of a set of cells configured to support L1/L2 based inter-cell mobility and also to inform a CU and DUs about inter-DU primary serving cell (PCell) changes. The mechanisms proposed herein may help reduce latency and achieve efficient use of signaling resources, as a UE moves between cells.

Disaggregated base station (gNB) components, such as DUs and a CU may have different responsibilities in a system that supports L1/L2 based inter-cell mobility.

For example, a DU may be responsible for obtaining L1/L2 measurements from a UE and determining which cells to activate/deactivate (from within the configured cell set) and when to switch a PCell within the activated cell set. The DU may also be responsible for providing the cell group configuration (e.g., via a CellGroupConfig information element-IE) of its served cells to the CU. This configuration may also indicate a set of cells interested in being configured with L1/L2 mobility, during initial access, reestablishment, resume and inter-DU mobility (as described with reference to FIG. 6, FIG. 7, FIG. 8 and FIG. 9).

In some cases, a DU may also provide multiple cell group configurations (which can constitute a configured cell set for L1/L2 mobility) to the CU. The CU may be responsible for deciding the final set of cells configured for L1/L2 based mobility after receiving the cell group configuration from (multiple) DUs.

The CU-DU signaling mechanisms proposed herein may enable a CU to be able to inform different DUs (whose cells constitute the configured cell set for L1/L2 mobility) about their neighbor DU identities and the corresponding cell identities served by those corresponding DUs.

One example of the CU-DU signaling mechanisms proposed herein may be understood with reference to the call flow diagram 1300 of FIG. 13.

As illustrated, a CU may receive information regarding one or more cell group configurations, from one or more distributed units (DUs). In the illustrated example, the CU receives a first cell group configuration from a first DU, DU1, that identifies cell 1, cell 2, and cell 3. The CU receives a second cell group configuration from a second DU, DU2, that identifies cell 4 and cell 5.

The CU may then decide, from the one or more cell group configurations, a first set of cells to configure for dynamic mobility signaling via physical (PHY) layer or medium access control (MAC) layer signaling. In the illustrated example, the CU decides to configure cells 1, 2, and 4 for L1/L2 based inter-cell mobility.

The CU may then transmit signaling, to the one or more DUs affiliated with the configured set of cells, to identify the one or more DUs and cells served thereby. In some cases, the signaling may indicate identities of DUs and the configured set of cells served by those DUs.

In the illustrated example, the CU transmits L1/L2 mobility assistance information that informs DU2 of DU1 and cells 1 and 2 that are configured for L1/L2 mobility and informs DU1 of DU2 and cell 4 that is configured for L1/L2 mobility. In some cases, the signaling may comprise a message for an elementary procedure (EP) without response (such messages may be referred to as Class 2 messages) or an application protocol (AP) message. For example, the assistance information may be conveyed in a new Class 2 message or in an existing F1 AP message (reused for this purpose).

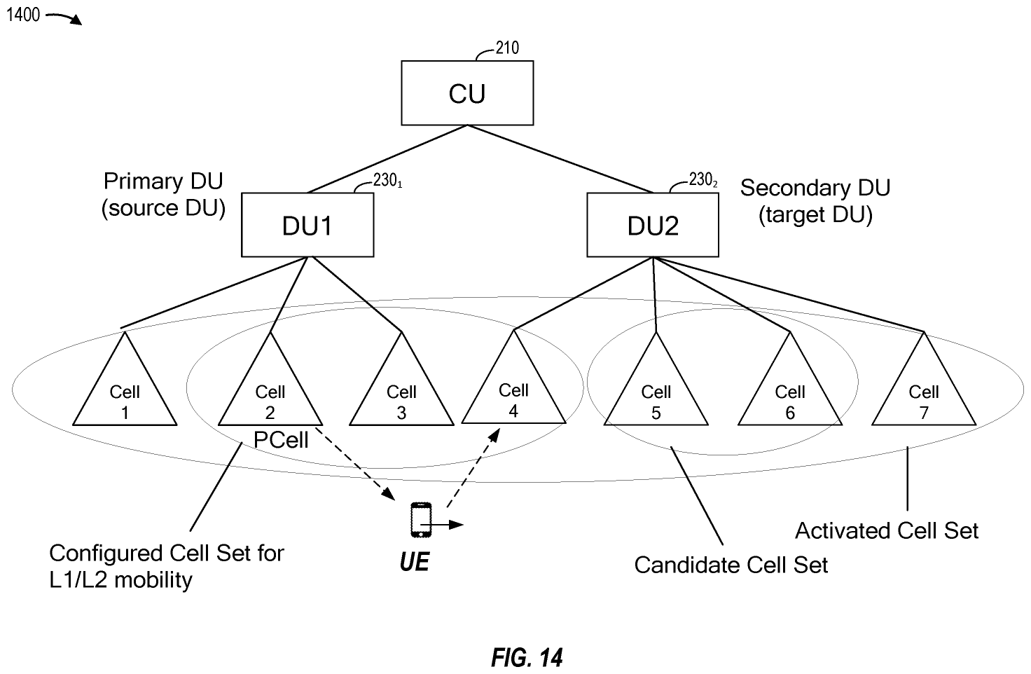

The CU-DU signaling mechanisms proposed herein may also enable information regarding an inter-DU Pcell change to be communicated. For example, the CU-DU signaling mechanisms proposed herein may help communicate information about a PCell change shown in diagram 1400 of FIG. 14 from a source PCell (cell 2 affiliated with DU1) to a target PCell (cell 4 affiliated with DU2).

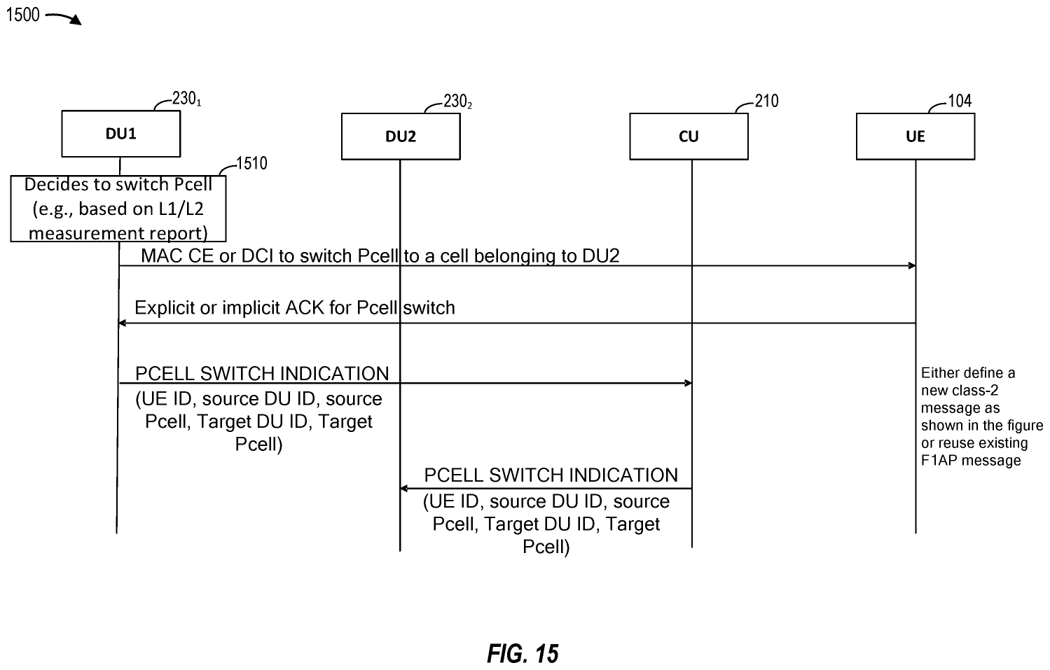

There are various options for how the CU may be notified after the inter-cell DU PCell switching. According to a first option, as illustrated in the call flow diagram 1500 of FIG. 15, the source DU (DU with the source PCell) may inform the CU about the PCell switch. As illustrated, the information flow in this example is from DU1 to the CU to DU2.

As illustrated, DU1 may decide to switch the PCell (e.g., to cell 4 of DU2, based on an L1/L2 measurement report). DU1 may trigger the switch via a MAC CE or DCI sent to the UE. The UE may explicitly or implicitly acknowledgment (ACK) the PCell switch.

In this example, DU1 informs the CU of the PCell switch via a PCell Switch Indication message. As illustrated, the indication may include the UE ID, source DU ID, source PCell ID, target DU ID, and target PCell ID. The CU may then inform the target DU of the switch (e.g., by forwarding the PCell Switch Indication). In some cases, the PCell Switch Indication may be conveyed in a new Class 2 message or in an existing F1 AP message (reused for this purpose).

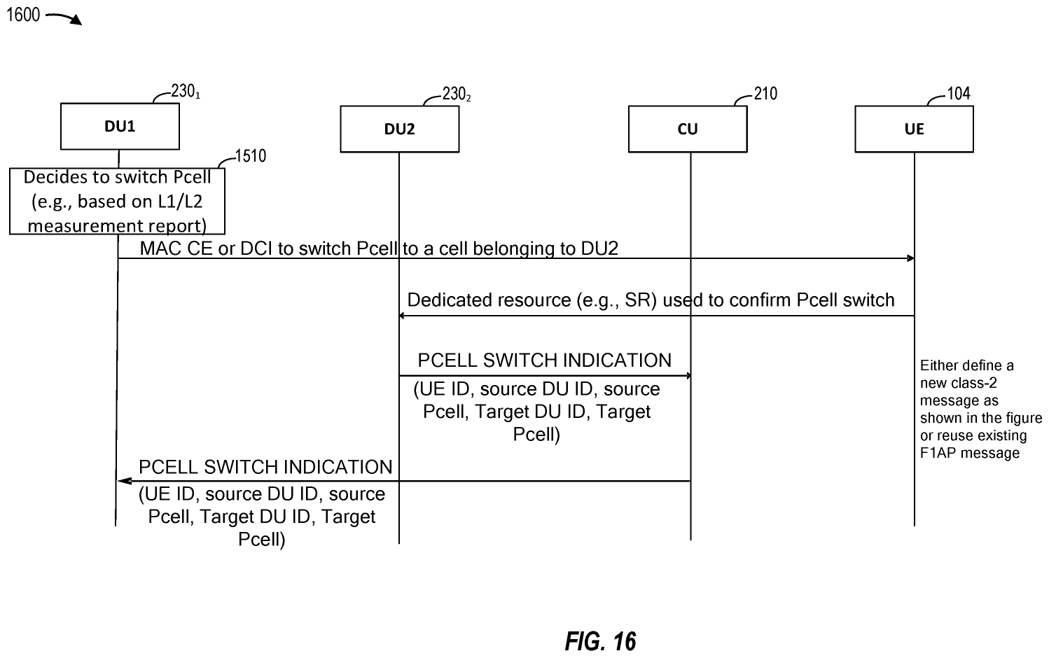

According to a second option, as illustrated in the call flow diagram 1600 of FIG. 16, the target DU (DU with the target PCell) may inform the CU about the PCell switch. As illustrated, the information flow in this example is from DU2 to the CU to DU1.

As with the example of FIG. 15, DU1 may decide to switch the PCell and may trigger the switch via a MAC CE or DCI sent to the UE. The UE may explicitly or implicitly acknowledgment (ACK) the PCell switch.

In this example, however, the UE may confirm the PCell switch to the target DU (DU2). In some cases, to allow the UE to inform the target DU, a dedicated resource (e.g. a scheduling request SR resource) may be used to confirm the Pcell switch.

After receiving confirmation, DU2 may inform the CU of the PCell switch via a PCell Switch Indication message. As described above, the indication may include the UE ID, source DU ID, source PCell ID, target DU ID, and target PCell ID. The CU may then inform the source DU (DU1) of the switch (e.g., by forwarding the PCell Switch Indication).

### Example Operations

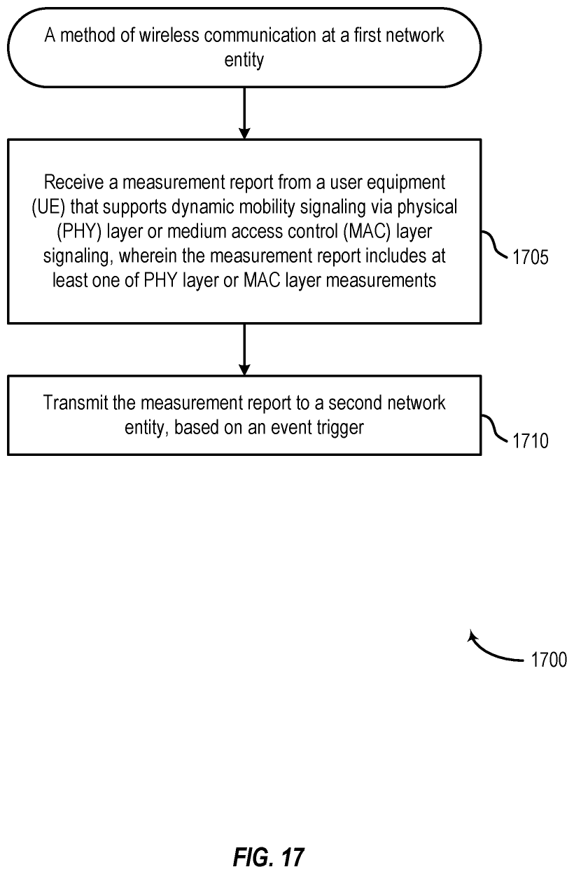

FIG. 17 shows an example of a method 1700 of wireless communication at a first network entity, such as a BS 102 of FIG. 1 and FIG. 3, or a disaggregated base station as discussed with respect to FIG. 2.

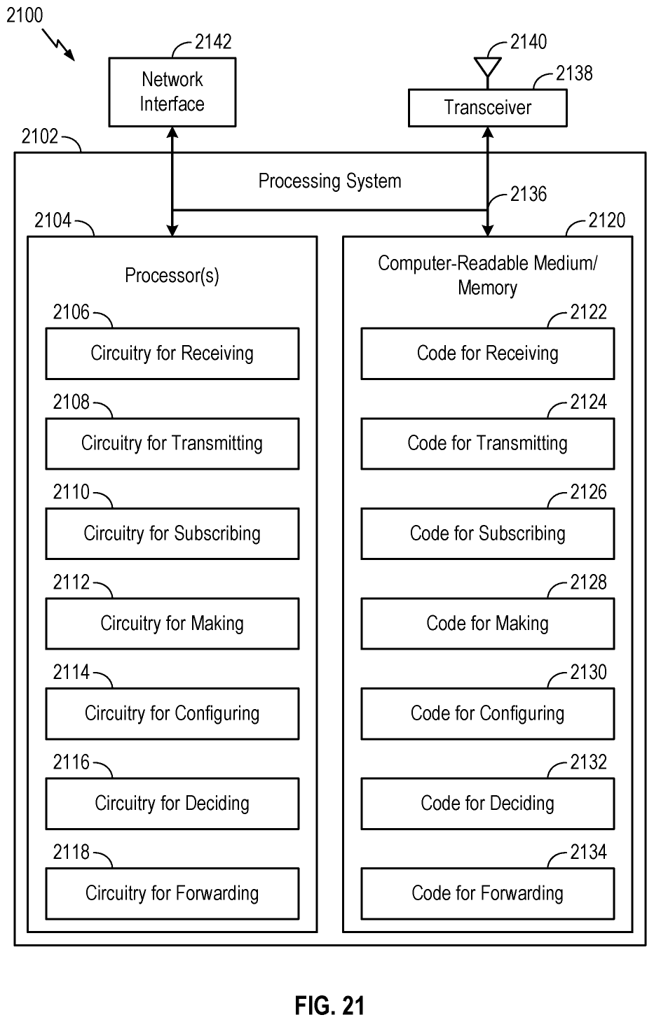

Method 1700 begins at step 1705 with receiving a measurement report from a user equipment (UE) that supports dynamic mobility signaling via physical (PHY) layer or medium access control (MAC) layer signaling, wherein the measurement report includes at least one of PHY layer or MAC layer measurements. In some cases, the operations of this step refer to, or may be performed by, circuitry for receiving and/or code for receiving as described with reference to FIG. 21.

Method 1700 then proceeds to step 1710 with transmitting the measurement report to a second network entity, based on an event trigger. In some cases, the operations of this step refer to, or may be performed by, circuitry for transmitting and/or code for transmitting as described with reference to FIG. 21.

In some aspects, the measurement report is transmitted via: a message for an elementary procedure (EP) without response; or an application protocol (AP) message.

In some aspects, the measurement report comprises at least one timestamp associated with the PHY layer or MAC layer measurements.

In some aspects, the event trigger comprises reception of the measurement report from the UE.

In some aspects, the event trigger is based on at least one of: a configured period or a radio quality value relative to a threshold.

In some aspects, the first network entity comprises a first distributed unit (DU); and the second network entity comprises a centralized unit (CU).

In some aspects, the event trigger comprises reception of a request from the CU; and the measurement report is transmitted in a response to the request.

In some aspects, the method 1700 further includes subscribing to receive measurement reports from at least a second DU with at least one of PHY layer or MAC layer measurements. In some cases, the operations of this step refer to, or may be performed by, circuitry for subscribing and/or code for subscribing as described with reference to FIG. 21.

In some aspects, the method 1700 further includes receiving, from the CU, measurement reports the first DU has subscribed to receive from the at least a second DU. In some cases, the operations of this step refer to, or may be performed by, circuitry for receiving and/or code for receiving as described with reference to FIG. 21.

In some aspects, the method 1700 further includes receiving, from the CU, measurement reports from at least a second DU with at least one of PHY layer or MAC layer measurements. In some cases, the operations of this step refer to, or may be performed by, circuitry for receiving and/or code for receiving as described with reference to FIG. 21.

In some aspects, the method 1700 further includes making primary serving cell (PCell) switching decisions based on the measurement reports from the at least a second DU. In some cases, the operations of this step refer to, or may be performed by, circuitry for making and/or code for making as described with reference to FIG. 21.

In some aspects, the measurement report comprises at least one target DU identifier and at least one target cell identifier.

In some aspects, the method 1700 further includes transmitting, to the CU, information regarding one or more cell group configurations for the first DU. In some cases, the operations of this step refer to, or may be performed by, circuitry for transmitting and/or code for transmitting as described with reference to FIG. 21.

In some aspects, the method 1700 further includes receiving signaling, from the CU, identifying at least a second DU associated with the target DU identifier and one or more cells served by the at least one second DU, the one or more cells including a cell associated with the target cell identifier. In some cases, the operations of this step refer to, or may be performed by, circuitry for receiving and/or code for receiving as described with reference to FIG. 21.

In some aspects, the event trigger is based on at least one of: a configured period or a radio quality value relative to a threshold.

In one aspect, method 1700, or any aspect related to it, may be performed by an apparatus, such as communications device 2100 of FIG. 21, which includes various components operable, configured, or adapted to perform the method 1700. Communications device 2100 is described below in further detail.

Note that FIG. 17 is just one example of a method, and other methods including fewer, additional, or alternative steps are possible consistent with this disclosure.

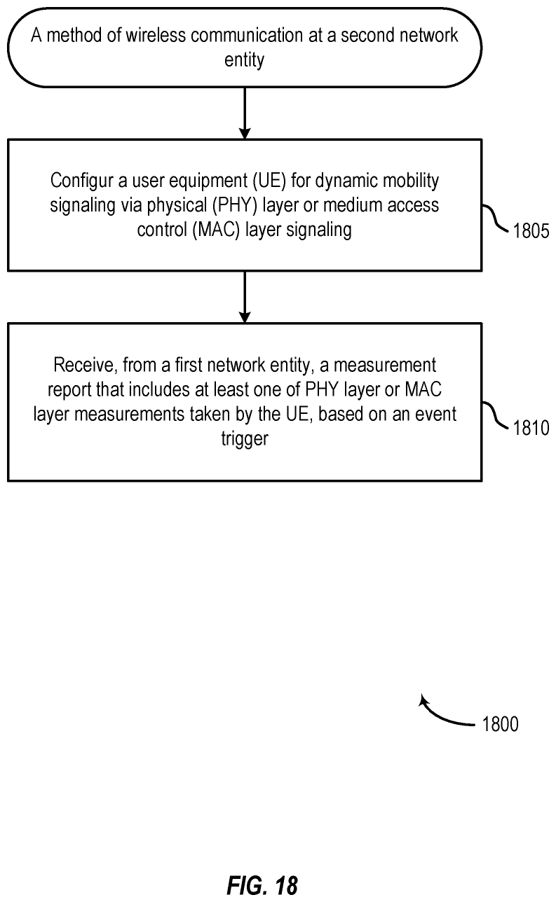

FIG. 18 shows an example of a method 1800 of wireless communication at a second network entity, such as a BS 102 of FIG. 1 and FIG. 3, or a disaggregated base station as discussed with respect to FIG. 2.

Method 1800 begins at step 1805 with configuring a user equipment (UE) for dynamic mobility signaling via physical (PHY) layer or medium access control (MAC) layer signaling. In some cases, the operations of this step refer to, or may be performed by, circuitry for configuring and/or code for configuring as described with reference to FIG. 21.

Method 1800 then proceeds to step 1810 with receiving, from a first network entity, a measurement report that includes at least one of PHY layer or MAC layer measurements taken by the UE, based on an event trigger. In some cases, the operations of this step refer to, or may be performed by, circuitry for receiving and/or code for receiving as described with reference to FIG. 21.

In some aspects, the measurement report is received via: a message for an elementary procedure (EP) without response; or an application protocol (AP) message.

In some aspects, the measurement report comprises at least one timestamp associated with the PHY layer or MAC layer measurements.

In some aspects, the first network entity comprises a first distributed unit (DU); and the second network entity comprises a centralized unit (CU).

In some aspects, the event trigger comprises reception of a request from the CU; and the measurement report is transmitted in a response to the request.

In some aspects, the event trigger comprises reception of the measurement report by the first DU from the UE.

In some aspects, the method 1800 further includes transmitting, to the first DU, measurement reports the first DU has subscribed to receive from at least a second DU. In some cases, the operations of this step refer to, or may be performed by, circuitry for transmitting and/or code for transmitting as described with reference to FIG. 21.

In some aspects, the measurement report comprises at least one target DU identifier and at least one target cell identifier.

In some aspects, the method 1800 further includes receiving, from one or more DUs, information regarding one or more cell group configurations. In some cases, the operations of this step refer to, or may be performed by, circuitry for receiving and/or code for receiving as described with reference to FIG. 21.

In some aspects, the method 1800 further includes deciding, from the one or more cell group configurations, a first set of cells to configure for dynamic mobility signaling via physical (PHY) layer or medium access control (MAC) layer signaling. In some cases, the operations of this step refer to, or may be performed by, circuitry for deciding and/or code for deciding as described with reference to FIG. 21.

In some aspects, the method 1800 further includes transmitting signaling, to the at least the first DU, identifying, at least a second DU associated with the target DU identifier and one or more cells served by the at least one second DU, the one or more cells including a cell associated with the target cell identifier. In some cases, the operations of this step refer to, or may be performed by, circuitry for transmitting and/or code for transmitting as described with reference to FIG. 21.

In one aspect, method 1800, or any aspect related to it, may be performed by an apparatus, such as communications device 2100 of FIG. 21, which includes various components operable, configured, or adapted to perform the method 1800. Communications device 2100 is described below in further detail.

Note that FIG. 18 is just one example of a method, and other methods including fewer, additional, or alternative steps are possible consistent with this disclosure.

FIG. 19 shows an example of a method 1900 of wireless communication at a first network entity, such as a BS 102 of FIG. 1 and FIG. 3, or a disaggregated base station as discussed with respect to FIG. 2.

Method 1900 begins at step 1905 with transmitting, to a second network entity, information regarding one or more cell group configurations for the first network entity. In some cases, the operations of this step refer to, or may be performed by, circuitry for transmitting and/or code for transmitting as described with reference to FIG. 21.

Method 1900 then proceeds to step 1910 with receiving signaling, from the second network entity, identifying at least a third network entity and one or more cells served thereby. In some cases, the operations of this step refer to, or may be performed by, circuitry for receiving and/or code for receiving as described with reference to FIG. 21.

In some aspects, the at least the first network entity comprises a first distributed unit (DU); the second network entity comprises a centralized unit (CU); and the third network entity comprises a second DU.

In some aspects, the method 1900 further includes transmitting, to the second network entity, an indication of a primary serving cell (PCell) switch for a user equipment (UE), from a first cell served by the first network entity to a second cell served by the third network entity or from the second cell served by the third network entity to the first cell served by the first network entity. In some cases, the operations of this step refer to, or may be performed by, circuitry for transmitting and/or code for transmitting as described with reference to FIG. 21.

In some aspects, the indication comprises: an ID of the UE, an ID of the first network entity, a ID of the first cell, an ID of the third network entity, and an ID of the second cell.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

FIG. 20 shows an example of a method 2000 of wireless communication at a second network entity, such as a BS 102 of FIG. 1 and FIG. 3, or a disaggregated base station as discussed with respect to FIG. 2.

Method 2000 begins at step 2005 with receiving, from at least a first network entity, information regarding one or more cell group configurations. In some cases, the operations of this step refer to, or may be performed by, circuitry for receiving and/or code for receiving as described with reference to FIG. 21.

Method 2000 then proceeds to step 2010 with deciding, from the one or more cell group configurations, a first set of cells to configure for dynamic mobility signaling via physical (PHY) layer or medium access control (MAC) layer signaling. In some cases, the operations of this step refer to, or may be performed by, circuitry for deciding and/or code for deciding as described with reference to FIG. 21.

Method 2000 then proceeds to step 2015 with transmitting signaling, to the at least the first network entity affiliated with the configured set of cells, to identify the at least the first network entity and cells served thereby. In some cases, the operations of this step refer to, or may be performed by, circuitry for transmitting and/or code for transmitting as described with reference to FIG. 21.

In some aspects, the at least the first network entity comprises at least a first distributed unit (DU); and the second network entity comprises a centralized unit (CU).

In some aspects, the method 2000 further includes receiving an indication of a primary serving cell (PCell) switch for a user equipment (UE), from a first cell served by the first DU to a second cell served by a second DU. In some cases, the operations of this step refer to, or may be performed by, circuitry for receiving and/or code for receiving as described with reference to FIG. 21.

In some aspects, the method 2000 further includes forwarding the indication of the PCell switch to the first DU or the second DU. In some cases, the operations of this step refer to, or may be performed by, circuitry for forwarding and/or code for forwarding as described with reference to FIG. 21.

In some aspects, the indication of the PCell switch is received from the first DU; and the method further comprises transmitting an indication of the PCell switch to the second DU.

In one aspect, method 2000, or any aspect related to it, may be performed by an apparatus, such as communications device 2100 of FIG. 21, which includes various components operable, configured, or adapted to perform the method 2000. Communications device 2100 is described below in further detail.

Note that FIG. 20 is just one example of a method, and other methods including fewer, additional, or alternative steps are possible consistent with this disclosure.

### Example Communications Device(s)

FIG. 21 depicts aspects of an example communications device 2100. In some aspects, communications device 2100 is a network entity, such as BS 102 of FIG. 1 and FIG. 3, or a disaggregated base station as discussed with respect to FIG. 2.

The communications device 2100 includes a processing system 2102 coupled to the transceiver 2138 (e.g., a transmitter and/or a receiver) and/or a network interface 2142. The transceiver 2138 is configured to transmit and receive signals for the communications device 2100 via the antenna 2140, such as the various signals as described herein. The network interface 2142 is configured to obtain and send signals for the communications device 2100 via communication link(s), such as a backhaul link, midhaul link, and/or fronthaul link as described herein, such as with respect to FIG. 2. The processing system 2102 may be configured to perform processing functions for the communications device 2100, including processing signals received and/or to be transmitted by the communications device 2100.

The processing system 2102 includes one or more processors 2104. In various aspects, one or more processors 2104 may be representative of one or more of receive processor 338, transmit processor 320, TX MIMO processor 330, and/or controller/processor 340, as described with respect to FIG. 3. The one or more processors 2104 are coupled to a computer-readable medium/memory 2120 via a bus 2136. In certain aspects, the computer-readable medium/memory 2120 is configured to store instructions (e.g., computer-executable code) that when executed by the one or more processors 2104, cause the one or more processors 2104 to perform the method 1700 described with respect to FIG. 17, or any aspect related to it; the method 1800 described with respect to FIG. 18, or any aspect related to it; the method 1900 described with respect to FIG. 19, or any aspect related to it; and the method 2000 described with respect to FIG. 20, or any aspect related to it. Note that reference to a processor of communications device 2100 performing a function may include one or more processors 2104 of communications device 2100 performing that function.

In the depicted example, the computer-readable medium/memory 2120 stores code (e.g., executable instructions), such as code for receiving 2122, code for transmitting 2124, code for subscribing 2126, code for making 2128, code for configuring 2130, code for deciding 2132, and code for forwarding 2134. Processing of the code for receiving 2122, code for transmitting 2124, code for subscribing 2126, code for making 2128, code for configuring 2130, code for deciding 2132, and code for forwarding 2134 may cause the communications device 2100 to perform the method 1700 described with respect to FIG. 17, or any aspect related to it; the method 1800 described with respect to FIG. 18, or any aspect related to it; the method 1900 described with respect to FIG. 19, or any aspect related to it; and the method 2000 described with respect to FIG. 20, or any aspect related to it.

The one or more processors 2104 include circuitry configured to implement (e.g., execute) the code stored in the computer-readable medium/memory 2120, including circuitry such as circuitry for receiving 2106, circuitry for transmitting 2108, circuitry for subscribing 2110, circuitry for making 2112, circuitry for configuring 2114, circuitry for deciding 2116, and circuitry for forwarding 2118. Processing with circuitry for receiving 2106, circuitry for transmitting 2108, circuitry for subscribing 2110, circuitry for making 2112, circuitry for configuring 2114, circuitry for deciding 2116, and circuitry for forwarding 2118 may cause the communications device 2100 to perform the method 1700 described with respect to FIG. 17, or any aspect related to it; the method 1800 described with respect to FIG. 18, or any aspect related to it; the method 1900 described with respect to FIG. 19, or any aspect related to it; and the method 2000 described with respect to FIG. 20, or any aspect related to it.

Various components of the communications device 2100 may provide means for performing the method 1700 described with respect to FIG. 17, or any aspect related to it; the method 1800 described with respect to FIG. 18, or any aspect related to it; the method 1900 described with respect to FIG. 19, or any aspect related to it; and the method 2000 described with respect to FIG. 20, or any aspect related to it. Means for transmitting, sending or outputting for transmission may include transceivers 332 and/or antenna(s) 334 of the BS 102 illustrated in FIG. 3 and/or the transceiver 2138 and the antenna 2140 of the communications device 2100 in FIG. 21. Means for receiving or obtaining may include transceivers 332 and/or antenna(s) 334 of the BS 102 illustrated in FIG. 3 and/or the transceiver 2138 and the antenna 2140 of the communications device 2100 in FIG. 21.

### Example Clauses

Implementation examples are described in the following numbered clauses:

Clause 1: A method of wireless communication at a first network entity, comprising: receiving a measurement report from a user equipment (UE) that supports dynamic mobility signaling via physical (PHY) layer or medium access control (MAC) layer signaling, wherein the measurement report includes at least one of PHY layer or MAC layer measurements; and transmitting the measurement report to a second network entity, based on an event trigger.

Clause 2: The method of Clause 1, wherein the measurement report is transmitted via: a message for an elementary procedure (EP) without response; or an application protocol (AP) message.

Clause 3: The method of any one of Clauses 1-2, wherein the measurement report comprises at least one timestamp associated with the PHY layer or MAC layer measurements.

Clause 4: The method of any one of Clauses 1-3, wherein the event trigger comprises reception of the measurement report from the UE.

Clause 5: The method of any one of Clauses 1-4, wherein the event trigger is based on at least one of: a configured period or a radio quality value relative to a threshold.

Clause 6: The method of any one of Clauses 1-5, wherein: the first network entity comprises a first distributed unit (DU); and the second network entity comprises a centralized unit (CU).

Clause 7: The method of Clause 6, wherein: the event trigger comprises reception of a request from the CU; and the measurement report is transmitted in a response to the request.

Clause 8: The method of Clause 6, further comprising subscribing to receive measurement reports from at least a second DU with at least one of PHY layer or MAC layer measurements.

Clause 9: The method of Clause 8, further comprising receiving, from the CU, measurement reports the first DU has subscribed to receive from the at least a second DU.

Clause 10: The method of Clause 8, further comprising: receiving, from the CU, measurement reports from at least a second DU with at least one of PHY layer or MAC layer measurements; and making primary serving cell (PCell) switching decisions based on the measurement reports from the at least a second DU.

Clause 11: The method of Clause 6, wherein the measurement report comprises at least one target DU identifier and at least one target cell identifier.

Clause 12: The method of Clause 11, further comprising: transmitting, to the CU, information regarding one or more cell group configurations for the first DU; and receiving signaling, from the CU, identifying at least a second DU associated with the target DU identifier and one or more cells served by the at least one second DU, the one or more cells including a cell associated with the target cell identifier.

Clause 16: The method of Clause 11, wherein the event trigger is based on at least one of: a configured period or a radio quality value relative to a threshold.

Clause 13: A method of wireless communication at a second network entity, comprising: configuring a user equipment (UE) for dynamic mobility signaling via physical (PHY) layer or medium access control (MAC) layer signaling; and receiving, from a first network entity, a measurement report that includes at least one of PHY layer or MAC layer measurements taken by the UE, based on an event trigger.

Clause 14: The method of Clause 13, wherein the measurement report is received via: a message for an elementary procedure (EP) without response; or an application protocol (AP) message.

Clause 15: The method of any one of Clauses 13-14, wherein the measurement report comprises at least one timestamp associated with the PHY layer or MAC layer measurements.

Clause 17: The method of any one of Clauses 13-16, wherein: the first network entity comprises a first distributed unit (DU); and the second network entity comprises a centralized unit (CU).

Clause 18: The method of Clause 17, wherein: the event trigger comprises reception of a request from the CU; and the measurement report is transmitted in a response to the request.

Clause 19: The method of Clause 17, wherein the event trigger comprises reception of the measurement report by the first DU from the UE.

Clause 20: The method of Clause 17, further comprising transmitting, to the first DU, measurement reports the first DU has subscribed to receive from at least a second DU.

Clause 21: The method of Clause 17, wherein the measurement report comprises at least one target DU identifier and at least one target cell identifier.

Clause 22: The method of Clause 17, further comprising: receiving, from one or more DUs, information regarding one or more cell group configurations; deciding, from the one or more cell group configurations, a first set of cells to configure for dynamic mobility signaling via physical (PHY) layer or medium access control (MAC) layer signaling; and transmitting signaling, to the at least the first DU, identifying, at least a second DU associated with the target DU identifier and one or more cells served by the at least one second DU, the one or more cells including a cell associated with the target cell identifier.

Clause 23: A method of wireless communication at a first network entity, comprising: transmitting, to a second network entity, information regarding one or more cell group configurations for the first network entity; and receiving signaling, from the second network entity, identifying at least a third network entity and one or more cells served thereby.

Clause 24: The method of Clause 23, wherein: the at least the first network entity comprises a first distributed unit (DU); the second network entity comprises a centralized unit (CU); and the third network entity comprises a second DU.

Clause 25: The method of any one of Clauses 23-24, further comprising: transmitting, to the second network entity, an indication of a primary serving cell (PCell) switch for a user equipment (UE), from a first cell served by the first network entity to a second cell served by the third network entity or from the second cell served by the third network entity to the first cell served by the first network entity.

Clause 26: The method of Clause 25, wherein the indication comprises: an ID of the UE, an ID of the first network entity, a ID of the first cell, an ID of the third network entity, and an ID of the second cell.

Clause 27: A method of wireless communication at a second network entity, comprising: receiving, from at least a first network entity, information regarding one or more cell group configurations; deciding, from the one or more cell group configurations, a first set of cells to configure for dynamic mobility signaling via physical (PHY) layer or medium access control (MAC) layer signaling; and transmitting signaling, to the at least the first network entity affiliated with the configured set of cells, to identify the at least the first network entity and cells served thereby.

Clause 28: The method of Clause 27, wherein: the at least the first network entity comprises at least a first distributed unit (DU); and the second network entity comprises a centralized unit (CU).

Clause 29: The method of Clause 28, further comprising: receiving an indication of a primary serving cell (PCell) switch for a user equipment (UE), from a first cell served by the first DU to a second cell served by a second DU; and forwarding the indication of the PCell switch to the first DU or the second DU.

Clause 30: The method of Clause 29, wherein: the indication of the PCell switch is received from the first DU; and the method further comprises transmitting an indication of the PCell switch to the second DU.

Clause 31: An apparatus, comprising: a memory comprising executable instructions; and a processor configured to execute the executable instructions and cause the apparatus to perform a method in accordance with any one of Clauses 1-30.

Clause 32: An apparatus, comprising means for performing a method in accordance with any one of Clauses 1-30.

Clause 33: A non-transitory computer-readable medium comprising executable instructions that, when executed by a processor of an apparatus, cause the apparatus to perform a method in accordance with any one of Clauses 1-30.

Clause 34: A computer program product embodied on a computer-readable storage medium comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a first network entity, comprising: a memory comprising computer-executable instructions; and one or more processors configured to execute the computer-executable instructions and cause the apparatus to:
receive a measurement report from a user equipment (UE) that supports dynamic mobility signaling via physical (PHY) layer or medium access control (MAC) layer signaling, wherein the measurement report includes at least one of PHY layer or MAC layer measurements; and
transmit the measurement report to a second network entity, based on an event trigger.

2. The apparatus of claim 1, wherein the measurement report is transmitted via:
a message for an elementary procedure (EP) without response; or
an application protocol (AP) message.

3. The apparatus of claim 1, wherein the measurement report comprises at least one timestamp associated with the PHY layer or MAC layer measurements.

4. The apparatus of claim 1, wherein the event trigger comprises reception of the measurement report from the UE.

5. The apparatus of claim 1, wherein the event trigger is based on at least one of: a configured period or a radio quality value relative to a threshold.

6. The apparatus of claim 1, wherein:
the first network entity comprises a first distributed unit (DU); and
the second network entity comprises a centralized unit (CU).

7. The apparatus of claim 6, wherein:
the event trigger comprises reception of a request from the CU; and
the measurement report is transmitted in a response to the request.

8. The apparatus of claim 6, wherein the one or more processors are further configured to execute the computer-executable instructions and cause the apparatus to subscribe to receive measurement reports from at least a second DU with at least one of PHY layer or MAC layer measurements.

9. The apparatus of claim 8, wherein the one or more processors are further configured to execute the computer-executable instructions and cause the apparatus to receive, from the CU, measurement reports the first DU has subscribed to receive from the at least a second DU.

10. The apparatus of claim 8, wherein the one or more processors are further configured to execute the computer-executable instructions and cause the apparatus to:
receive, from the CU, measurement reports from at least a second DU with at least one of PHY layer or MAC layer measurements; and
make primary serving cell (PCell) switching decisions based on the measurement reports from the at least a second DU.

11. The apparatus of claim 6, wherein the measurement report comprises at least one target DU identifier and at least one target cell identifier.

12. The apparatus of claim 11, wherein the one or more processors are further configured to execute the computer-executable instructions and cause the apparatus to:
transmit, to the CU, information regarding one or more cell group configurations for the first DU; and
receive signaling, from the CU, identifying
at least a second DU associated with the target DU identifier and
one or more cells served by the at least one second DU, the one or more cells including a cell associated with the target cell identifier.

13. An apparatus for wireless communication at a second network entity, comprising: a memory comprising computer-executable instructions; and one or more processors configured to execute the computer-executable instructions and cause the apparatus to:
configure a user equipment (UE) for dynamic mobility signaling via physical (PHY) layer or medium access control (MAC) layer signaling; and
receive, from a first network entity, a measurement report that includes at least one of PHY layer or MAC layer measurements taken by the UE, based on an event trigger.

14. The apparatus of claim 13, wherein the measurement report is received via:
a message for an elementary procedure (EP) without response; or
an application protocol (AP) message.

15. The apparatus of claim 13, wherein the measurement report comprises at least one timestamp associated with the PHY layer or MAC layer measurements.

16. The apparatus of claim 11, wherein the event trigger is based on at least one of: a configured period or a radio quality value relative to a threshold.

17. The apparatus of claim 13, wherein:
the first network entity comprises a first distributed unit (DU); and
the second network entity comprises a centralized unit (CU).

18. The apparatus of claim 17, wherein:
the event trigger comprises reception of a request from the CU; and
the measurement report is transmitted in a response to the request.

19. The apparatus of claim 17, wherein the event trigger comprises reception of the measurement report by the first DU from the UE.

20. The apparatus of claim 17, wherein the one or more processors are further configured to execute the computer-executable instructions and cause the apparatus to transmit, to the first DU, measurement reports the first DU has subscribed to receive from at least a second DU.

21. The apparatus of claim 17, wherein the measurement report comprises at least one target DU identifier and at least one target cell identifier.

22. The apparatus of claim 17, wherein the one or more processors are further configured to execute the computer-executable instructions and cause the apparatus to:
receive, from one or more DUs, information regarding one or more cell group configurations;
decide, from the one or more cell group configurations, a first set of cells to configure for dynamic mobility signaling via physical (PHY) layer or medium access control (MAC) layer signaling; and
transmit signaling, to the at least the first DU, identifying,
at least a second DU associated with the target DU identifier and
one or more cells served by the at least one second DU, the one or more cells including a cell associated with the target cell identifier.

23. An apparatus for wireless communication at a first network entity, comprising: a memory comprising computer-executable instructions; and one or more processors configured to execute the computer-executable instructions and cause the apparatus to:
transmit, to a second network entity, information regarding one or more cell group configurations for the first network entity; and
receive signaling, from the second network entity, identifying at least a third network entity and one or more cells served thereby.

24. The apparatus of claim 23, wherein:
the at least the first network entity comprises a first distributed unit (DU);
the second network entity comprises a centralized unit (CU); and
the third network entity comprises a second DU.

25. The apparatus of claim 23, wherein the one or more processors are further configured to execute the computer-executable instructions and cause the apparatus to:
transmit, to the second network entity, an indication of a primary serving cell (PCell) switch for a user equipment (UE), from a first cell served by the first network entity to a second cell served by the third network entity or from the second cell served by the third network entity to the first cell served by the first network entity.

26. The apparatus of claim 25, wherein the indication comprises: an ID of the UE, an ID of the first network entity, a ID of the first cell, an ID of the third network entity, and an ID of the second cell.

27. An apparatus for wireless communication at a second network entity, comprising: a memory comprising computer-executable instructions; and one or more processors configured to execute the computer-executable instructions and cause the apparatus to:
receive, from at least a first network entity, information regarding one or more cell group configurations;
decide, from the one or more cell group configurations, a first set of cells to configure for dynamic mobility signaling via physical (PHY) layer or medium access control (MAC) layer signaling; and
transmit signaling, to the at least the first network entity affiliated with the configured set of cells, to identify the at least the first network entity and cells served thereby.

28. The apparatus of claim 27, wherein:
the at least the first network entity comprises at least a first distributed unit (DU); and
the second network entity comprises a centralized unit (CU).

29. The apparatus of claim 28, wherein the one or more processors are further configured to execute the computer-executable instructions and cause the apparatus to:
receive an indication of a primary serving cell (PCell) switch for a user equipment (UE), from a first cell served by the first DU to a second cell served by a second DU; and
forward the indication of the PCell switch to the first DU or the second DU.

30. The apparatus of claim 29, wherein:
the indication of the PCell switch is received from the first DU; and
the one or more processors are further configured to execute the computer-executable instructions and cause the apparatus to transmit an indication of the PCell switch to the second DU.
